(19) United States
(12) Patent Application Publication
(10) Pub. No.: US 2011/0038518 A1
(43) Pub. Date: Feb. 17, 2011

(54) Roadmap method for the superimposed representation of images

(76) Inventor: Martin Spahn, Erlangen (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/853,344

(22) Filed: Aug. 10, 2010

(30) Foreign Application Priority Data
Aug. 12, 2009 (DE) 10 2009 037 242.3

(51) Int. Cl. G06K 9/00; G01N 23/04; G06K 9/46

(52) U.S. Cl. 382/128; 378/62; 382/195

(57) ABSTRACT

A method for superimposed representation of images is provided. A first original image is detected in a system dose regulation phase and a second original image is detected during a filling phase in which the vessels are filled with contrast agent by a detector for generating images having pixels arranged in a matrix. Two roadmap images are generated by processing the original images. The roadmap images are alternately represented. A temporal “superimposition” is achieved with the alternate representation of a diagnostic image, for instance a vessel tree and of live images of the interventional phase, for instance those of a moving guide wire so that no complicated connections are needed. No contrast of the individual images gets lost.

### CROSS REFERENCE TO RELATED APPLICATIONS

This application claims priority of German application No. 10 2009 037 242.3 filed Aug. 12, 2009, which is incorporated by reference herein in its entirety.

### FIELD OF THE INVENTION

The invention relates to a method for the superimposed representation of images, for instance a roadmap method, in which, original images are recorded in a first phase during the system dose regulation phase and then x-ray images are recorded during a second phase, for instance a filling phase, in which the vessels are filled with contrast agent, from which roadmap images develop following if necessary further image processing.

### BACKGROUND OF THE INVENTION

For a diagnostic examination and interventional procedures in the field of cardiology for instance, radiology and neurosurgery are used to image interventional x-ray systems, the typical essential features of which may be a robot controlled C-arm, to which an x-ray tube and an x-ray detector are attached, a patient support couch, a high voltage generator for generating the tube voltage, a system control unit and an imaging system including at least one monitor. A C-arm x-ray system of this type shown in FIG. 1 comprises for instance a C-arm 2 rotatably mounted on a stand in the form of a hexagonal industrial or articulated robot 2, to the ends of which an x-ray radiation source, for instance an X-ray emitter 3 having x-ray tube and collimator, and a x-ray image detector 4 as an image recording unit, are attached.

By means of the articulated robot 1 known from U.S. Pat. No. 7,500,784 B2 for instance, which preferably comprises six axes of rotation and six degrees of freedom, the C-arm 2 can be adjusted spatially in an arbitrary fashion, for instance by being rotated about a rotation center between the x-ray emitter 3 and the x-ray detector 4. The inventive x-ray system 1 to 4 can be rotated in particular about a rotation center and axes of rotation in the C-arm plane of the x-ray image detector 4, preferably about the axes of rotation intersecting the center point of the x-ray image detector 4 and about the center point of the x-ray image detector 4.

The known articulated robot 1 has a base frame, which is fixedly mounted to a floor for instance. A carousel is rotatably fastened thereto about a first axis of rotation. A robot lever is pivotably attached to the carousel about a second axis of rotation, to which robot lever a robot aim is rotatably fastened about a third axis of rotation. A robot hand is rotatably attached to the end of the robot aim about a fourth axis of rotation. The robot hand comprises a fastening element for the C-arm 2, which can be pivoted about a fifth axis of rotation and rotated about a sixth axis of rotation which proceeds at right angles thereto.

The realization of the x-ray diagnostics facility is not dependent on the industrial robot. Conventional C-arm devices can also be used.

The x-ray image detector 4 may be a rectangular or quadratic, flat semiconductor detector, which is preferably made from amorphous silicon (a-Si). Integrating and possibly numerative CMOS detectors can however also be used.

A patient 6 to be examined is positioned as an examination object on a patient support couch 5 for recording a heart for instance in the radiation path of the x-ray emitter 3. A system control unit 7 comprising an imaging system 8 is connected to the x-ray diagnostics facility, said imaging system 8 receiving and processing the image signals of the x-ray image detector 4 (control elements are not shown for instance). The x-ray images can then be observed on a monitor 9.

Different imaging methods are used nowadays in interventional vascular radiology, which assist with moving or positioning interventional objects “IOs” such as wires, coils, balloons, stents, prostheses, catheters etc. in the vessel tree. These are so-called roadmap methods. In this way the vessel tree recorded at a preceding point in time is superimposed using the current fluoroscopy, during which the IO is moved. These may be the following methods for instance:

Classical Roadmap:
Here the vascular tree filling with contrast agent is recorded under fluoroscopy conditions and a mask image is constructed from the individual original images. This is then superimposed onto the current fluoroscopy images.

DSA-Based Roadmap:

A suitable DSA image is used here for the mask.

3-D-Based Roadmap:
A suitable projection of a 3D vessel tree data record of the current fluoroscopy is superimposed here.

All these methods have a common feature; the two data records, at least the mask image and the current image of the active fluoroscopy series, are achieved in the local space, in other words by mixing the gray scale values of both data records. Here the dark wire of the current fluoroscopy is superimposed onto the bright vessel tree of the mask image for instance. With the pixel-by-pixel superimposition, the addition of the one original image A to a certain percentage μ to the other original image B,

C(i,j)=μ·A(i,j)+(1−μ)·B(i,j)

causes the new, superimposed roadmap image C to lose contrast in each pixel (i,j). The dark wire becomes less dark, the bright vessel loses brightness.

This also generally applies if gray scale value adjustments are subsequently still performed in the case of the resulting roadmap image C, like for instance gray scale value windowing, or if more complex superimposition techniques are used in the local space (and/or gray scale value space), which may alternatively be used. Current conventional methods of this type are explained in more detail with the aid of FIG. 2. FIG. 2 shows a known roadmap method, in which a first original image A 10, for instance a mask image, and a second original image B or an original image sequence Bₙ 11, for instance a current fluoroscopy image or a fluoroscopy series, are generated by a medical imaging system, for instance the C-arm x-ray system shown in FIG. 1. An image processing 12 enables the original images 10 and 11 or the original image sequence Bₙ 11 to be superimposed to form a roadmap image C or a roadmap image sequence 13, and then to be fed to the monitor 9 shown in FIG. 1 for representation purposes 13.

### SUMMARY OF THE INVENTION

The object underlying the invention is to improve the superimposed representation of images according to the roadmap method of the type cited in the introduction in an easy fashion.

The object is achieved in accordance with the invention for a method and for an apparatus by the features specified in the independent claims. Advantageous embodiments are specified in the dependent claims.

The object is achieved in accordance with the invention for a method by the following steps:
a) Detecting at least one first original image and at least one second original image by means of a detector for generating images having pixels arranged in the manner of a matrix,
b) Processing at least one of the original images in order to generate at least two roadmap images,
c) Alternately detecting the roadmap images and
d) Alternately reproducing the at least two roadmap images.

A temporal “superimposition” is achieved as a result, so that no complicated connections are needed. Also no contrast of the individual images gets lost.

It has proven advantageous if the processing of the individual original images according to step b) involves an inversion of one of the original images, a sharpening and/or a general gray scale value adjustment being implemented.

In accordance with the invention, the first original image may be a mask image and the second original image may be a current fluoroscopy image.

Advantageously, for representation purposes, at least one original image can be derived from an original image sequence as a second original image.

In accordance with the invention, several original images can be routed for a consecutive representation.

It has proven advantageous if the original images are created with at least one medical imaging system from the group comprising x-ray system, CT system, MR system, ultrasound system and/or PET system, with the original images corresponding in terms of their projection.

A flickering of the images is prevented if the representation takes place with an increased frequency compared with the reproduction frequency.

If necessary, the average and/or general gray scale value of the two original images or original image sequence n is to be matched to one another in order to further reduce the impression of the flickering.

The object is achieved in accordance with the invention for an apparatus comprising
an apparatus for detecting at least two original images with pixels arranged in the manner of a matrix,
at least one image processing for the original images, so that at least two roadmap images develop,
an electronic toggle switch for alternately requesting the at least two roadmap images and
a monitor for alternately representing the at least two roadmap images.

It has proven advantageous for the image processing to be embodied such that an inversion of one of the original images, a sharpening and/or a general gray scale value adjustment can be implemented.

In accordance with the invention, the medical imaging system can be selected from the group comprising x-ray system, CT system, MR system, ultrasound system and/or PET system.

### BRIEF DESCRIPTION OF THE DRAWINGS

The invention is described in more detail below with the aid of exemplary embodiments shown in the drawing, in which:

FIG. 1 shows a known x-ray C-arm system for radiology, cardiology, or neurosurgery comprising an industrial robot as a supporting apparatus,

FIG. 2 shows the previously conventional method for the superimposed representation of two images or also one image with an image sequence,

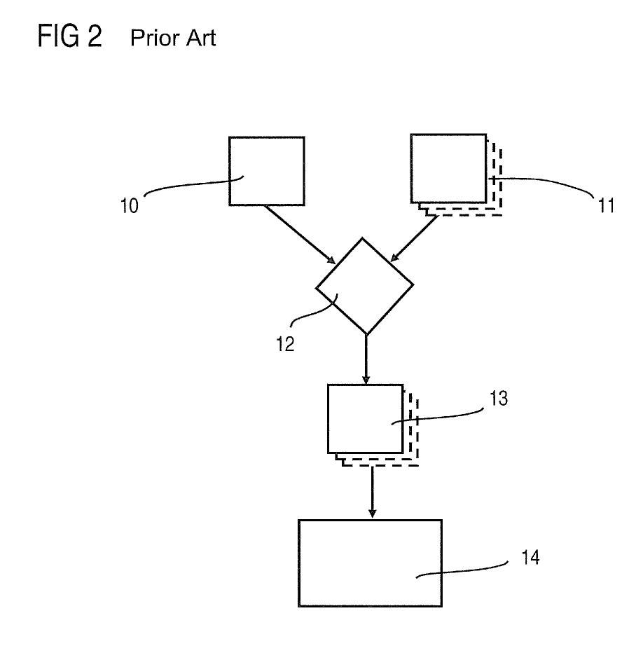

FIG. 3 shows an embodiment of the roadmap according to the new superimposition method, in which the images arriving for representation are each displayed alternately on the monitor, and

FIG. 4 shows a further embodiment of the inventive roadmap with images of several modalities.

### DETAILED DESCRIPTION OF THE INVENTION

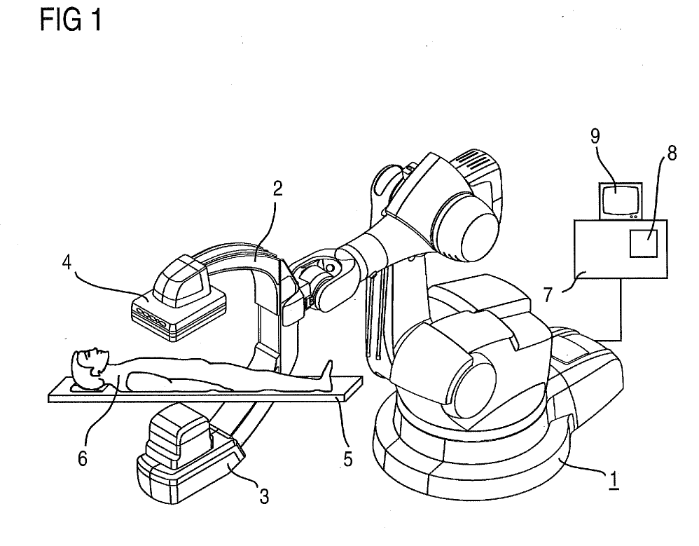

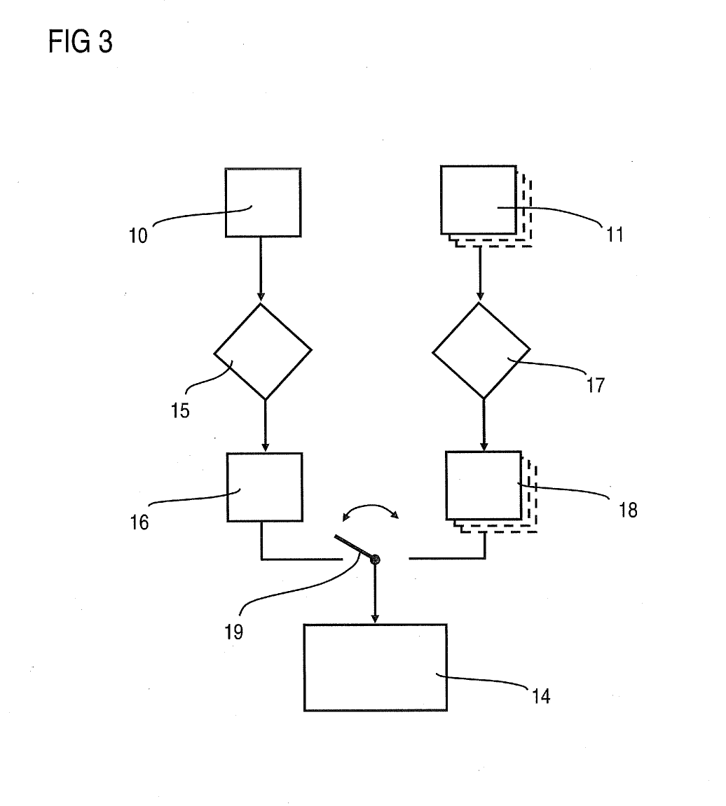

The inventive roadmap method for the superimposed representation of images is now shown in more detail with the aid of FIG. 3. Also with this method, a first original image A 10, for instance a mask image, and a second original image B or an original image sequence Bₙ 11, for instance a current fluoroscopy image or a fluoroscopy series, are generated by means of a medical imaging system, for instance the C-arm x-ray system shown in FIG. 1. These original images 10 and 11 are each fed separately to an imaging processing 15 and 17, which generate roadmap images A′ 16 and B′ and/or a roadmap image sequence B′ₙ 18. These roadmap images A′ 16 and B′ and/or roadmap image sequence B′ₙ 18 are requested alternately by an electronic toggle switch 19 and are routed to the monitor 9 for representation purposes 14 for instance, which enables an alternate reproduction of the roadmap images A′ 16 and B′ and/or roadmap image sequence B′ₙ 18.

The main idea was now to propose a temporal “superimposition” in order to improve the superimposition of two original images (current fluoroscopy image and mask image). In this process the original images A and B possibly remain separate at first in order to be processed to form roadmap images A′ 16 and B′ and/or roadmap sequence B′ₙ 18. This can take place for instance by, inter alia, inverting one of the original images A or B, sharpening or general gray scale value adjustment. The roadmap images A′ 16 and B′ and/or roadmap image sequence B′ₙ 18 are then shown alternately one after the other, i.e. presented alternately to the eye with high frequency, with attention having to be paid to the correct position on the monitor by means of the selected projection. Here the original contrast of each original image is essentially retained. Therefore here the superimposition takes place in the brain and not on the plane of the image processing. By alternately representing the images, they can be used originally, i.e. the full contrast is retained.

If individual images 10 and 11 (A and B) are shown as temporally superimposed in each instance, the roadmap images 16 and 18 (A′ and B′) are easily consecutively reproduced (following a separate image processing). In some instances, this takes place with a higher frequency than in the case of a representation of only one image, in order to prevent flickering.

If an individual original image A 10 and an original image sequence Bₙ 11 or original image series are to be superimposed, the roadmap image 16 (A′) is shown respectively between a roadmap image 18 (B′) of the original image sequence Bₙ (n=1, N) 11. To prevent the impression of flickering, the process must be carried out at in some instances with an image reproduction frequency which is higher than usual. Nowadays, x-ray images for instance, which are recorded with a recording frequency of 15 B/s or also only 4 B/s, are shown with 30 B/s for instance or also considerably higher in the case of the image reproduction. This generally results in a repeated image representation. The images are then each shown 2 and/or 8 times per second in this example. Here the roadmap image A′ 16 and the roadmap image B′ₙ 18 are always shown alternately in the case of the image repetition.

With the new method, on account of the original acquisition frequency of the original image sequence B for instance or for optophysiological reasons, a higher, possibly double frequency must be shown since the mask image must still additionally be shown occasionally in each instance.

If necessary, the general gray scale value of the two original images or original image sequence n is to be matched to one another in order to further reduce the impression of flickering.

Flickering may occur as a result of two things:
as a result of an excessively low image reproduction frequency. This can be countered by a sufficiently high frequency, with a repetition possibly being selected.
Gray scale value differences between the individual image data records (A, B, possibly (C)). Particularly advantageous image data would be used here, the background of which is already essentially flat (solid gray scale value) and in which only the objects are shown in each instance. This may be a DSA image (vessel tree above gray)=A′ or a type of roadmap image=fluoroscopy image (wire with anatomy) minus mask image (anatomy) with the result of wire above grey=B′(n). The average gray scale value of the images A′ and B′ (n) can then namely be easily aligned.

There must be no “subtraction images”. The important thing is essentially that the image reproduction frequency is selected so high that the “superimposition” goes on in the head.

The roadmap method can be expanded to the superimposition of any medical images, which match in terms of their projection. For instance, an alternating representation 14 of x-ray and CT images, x-ray and MR images, CT and ultrasound images, MR and ultrasound images and/or MR and PET images etc. is also possible.

Instead of two images or images sequence n in each instance, several images or image sequences n of different modalities can at the same time also be alternately superimposed. The images must then be displayed consecutively in each instance and the frequency is possibly further increased.

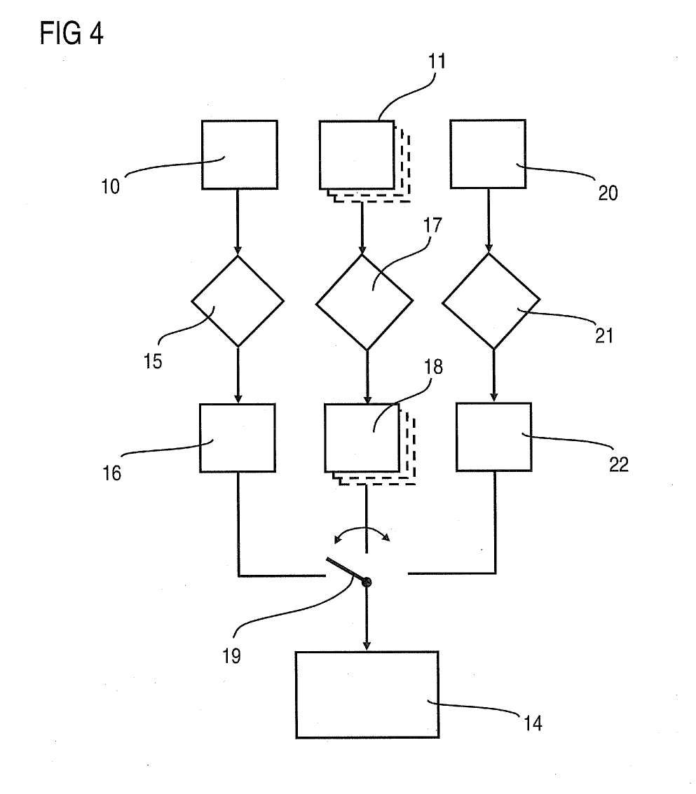

This is illustrated in FIG. 4, in which, in addition to the vertical input data records with the images or image sequences 10, 11, 16, 18 and image processings 15, 17 known from FIG. 3, a further vertical input data record is provided, which [lacuna] a third original image 20 D or original image Dₙ and a third image processing 21, so that a third roadmap image 22 D′ is generated in a known fashion. The images 10, 16 of the first vertical input data record contain a DSA vessel tree for instance, those of the second vertical input data record a fluoroscopy live image, in which an object to be displaced is reproduced, and those of the third vertical input data record an image of the functional MR (fMR), which can contain color information.

1.-10. (canceled)

11. A method for representing a superimposed roadmap image, comprising:
detecting a first original image in a system dose regulation phase by an image detector of an imaging recording system;
detecting a second original image in a filling phase by the image detector of the imaging recording system;
processing the first original image for generating a first roadmap image by an imaging processing device;
processing the second original images for generating a second roadmap image by the imaging processing device; and
alternately representing the first and the second roadmap images on a monitor for representing a superimposed roadmap image.

12. The method as claimed in claim 11, wherein the processing of the first and the second original images comprises an inversion of the first and the second original images, a sharpening adjustment of the first and the second original images, and/or a general gray-value adjustment of the first and the second original images.

13. The method as claimed in claim 11, wherein the first original image is a mask image and the second original image is a current fluoroscopy image.

14. The method as claimed in claim 11, wherein an original image sequence is generated in the filling phase and one image from the original image sequence is represented as the second original image.

15. The method as claimed in claim 11, wherein the steps of the method are repeated for consecutively representing further superimposed roadmap images.

16. The method as claimed in claim 11, wherein the roadmap image is represented with a frequency which is higher than a frequency of detecting the first and the second original image.

17. The method as claimed in claim 16, wherein the frequency of detecting the first and the second original image is high so that the roadmap image is superimposed in a head of a user.

18. The method as claimed in claim 11, wherein the imaging recording system is selected from the group consisting of: x-ray system, CT system, MR system, ultrasound system, and PET system.

19. The method as claimed in claim 11, wherein the first and the second original image comprises pixels arranged in a matrix.

20. A medical imaging system for representing a superimposed roadmap image, comprising:
an image detector that detects a first original image in a system dose regulation phase and a second original image in a filling phase; having pixels arranged in the manner of a matrix,
an image processing device that processes the first and the second original image to generate a first roadmap image and a second roadmap image respectively;
an electronic toggle that switches for alternately requesting the first and the second roadmap image; and
a monitor that alternately represents the first and the second roadmap image for representing a superimposed roadmap image.

21. The medical imaging system as claimed in claim 20, wherein the first and the second original image is processed for an inversion, a sharpening adjustment, and/or a general gray scale value adjustment.

22. The medical imaging system as claimed in claim 20, wherein the first original image is a mask image and the second original image is a current fluoroscopy image.

23. The medical imaging system as claimed in claim 20, wherein an original image sequence is generated in the filling phase and one image from the original image sequence is represented as the second original image.

24. The medical imaging system as claimed in claim 20, wherein the image detector detects a plurality of first and second original images for consecutively representing further superimposed roadmap images.

25. The medical imaging system as claimed in claim 20, wherein the roadmap image is represented with a frequency which is higher than a frequency of detecting the first and the second original image.

26. The medical imaging system as claimed in claim 25, wherein the frequency of detecting the first and the second original image is high so that the roadmap image is superimposed in a head of a user.

27. The medical imaging system as claimed in claim 20, wherein the medical imaging system is selected from the group consisting of: an x-ray system, a CT system, a MR system, an ultrasound system, and PET system.
